(19) United States
(12) Patent Application Publication
(10) Pub. No.: US 2017/0197308 A1
(43) Pub. Date: Jul. 13, 2017

(54) TEACHING DATA GENERATING DEVICE AND TEACHING DATA-GENERATING METHOD FOR WORK ROBOT

(71) Applicant: NABTESCO CORPORATION, Tokyo (JP)

(72) Inventors: Takahito AZUMA, Mie (JP); Masato UCHIHARA, Mie (JP); Kohei NAGAHARA, Mie (JP)

(21) Appl. No.: 15/315,285

(22) PCT Filed: May 19, 2015
(86) PCT No.: PCT/JP2015/064370

§ 371 Date: Nov. 30, 2016

(30) Foreign Application Priority Data
Jun. 6, 2014 (JP) 2014-118065

(51) Int. Cl. B25J 9/16

(52) U.S. Cl. CPC B25J 9/163

(57) ABSTRACT

A teaching data generating device for a work robot includes: a storage unit (22) that stores three-dimensional models of a plurality of work robots (12), a display unit (26) that displays a virtual space that represents an actual workspace (WS) where a work robot (12) is set up and displays at least one three-dimensional model selected from among the three-dimensional models of the plurality of work robots stored in the storage unit (22) such that the three-dimensional model is configured in the virtual space, an operation control unit that operates the three-dimensional model displayed on the display unit (26) in accordance with an instruction to operate the three-dimensional model, and a teaching data generating unit that generates teaching data for the work robot (12) using data of motions of the three-dimensional model operated by the operation control unit.

### TECHNICAL FIELD

The present invention relates to a teaching data generating device and a teaching data generating method for a work robot.

### BACKGROUND

Offline teaching has been known as one of teaching methods for working robots as disclosed in Patent Literatures 1 and 2. In the offline teaching, a model of a working robot is set in a virtual space and operations of the working robot are simulated to create teaching data. The offline teaching has the following advantages. The teaching does not stop a factory production line because the teaching is carried out without using an actual working robot. Moreover there is no possibility of damaging the working robot and objects.

In the offline teaching, a teaching process is performed by operating a working robot in a virtual space. Therefore even if a user does not know how to operate the actual working robot, as long as the user has been experienced in operating other work robots, the user can perform the teaching in a relatively safe manner compared to a teaching playback method in which teaching is performed by actually operating a substantial working robot using a teach pendant. However for a person who considers introducing working robots into a workplace where has no experience of using working robots, it would be difficult to image motions of the working robots set in the actual site and difficult to capture a sense of operating the robots such as how much the working robot should be moved even when teaching is performed by operating the working robot in a virtual space. Moreover, programming of the teaching as itself may be complicated and it may discourage the person from introducing the working robots into the workplace.

### RELEVANT REFERENCES

### Patent Literature

Patent Literature 1: Japanese Patent Application Publication No. 2007-272309 Patent Literature 2: Japanese Patent Application Publication No. 2008-20993

### SUMMARY

One object of the invention is to provide a teaching data generating device and a teaching data generating method for a work robot with which workload of offline teaching can be reduced.

According to one aspect of the invention, provided is a teaching data generating device for a work robot. The teaching data generating device includes a storage unit that stores three-dimensional models of a plurality of work robots, a display unit that displays a virtual space that represents an actual workspace where a work robot is set up and displays at least one three-dimensional model selected from among the three-dimensional models of the plurality of work robots stored in the storage unit such that the three-dimensional model is configured in the virtual space, an operation control unit that operates the three-dimensional model displayed on the display unit in accordance with an instruction to operate the three-dimensional model, and a teaching data generating unit that generates teaching data for the work robot using data of motions of the three-dimensional model operated by the operation control unit.

According to another aspect of the invention, provided is a teaching data generating method for a work robot. The method includes displaying, on a display unit, a virtual space that represents an actual workspace where a work robot is set up and displaying, on the display unit, at least one three-dimensional model selected from among three-dimensional models of a plurality of work robots stored in a storage unit such that the selected model is configured in the virtual space; operating the three-dimensional model displayed on the display unit in accordance with an instruction to operate the three dimensional model; and generating teaching data for the work robot based on data of motions which the operated three-dimensional model makes.

### BRIEF DESCRIPTION OF THE DRAWINGS

FIG. 1 schematically illustrates a configuration of a teaching data generating device for a work robot according to an embodiment of the invention.

FIG. 2 is an explanatory drawing for functionalities which the teaching data generating device has.

FIGS. 3a and 3b are explanatory drawings for an image captured by a camera.

FIG. 4 illustrates a virtual space and a three-dimensional model displayed on a display unit.

FIG. 5 illustrates a three-dimensional model.

FIG. 6a schematically illustrates a state where a miniature model is connected to an external input.

FIG. 6b schematically illustrates a computer that outputs audio information is connected to the external input.

FIG. 7 is an explanatory drawing for a teaching data generating method for a work robot according to the embodiment of the invention.

### DESCRIPTION OF THE PREFERRED EMBODIMENTS

The embodiments of the invention will now be described with reference to the drawings.

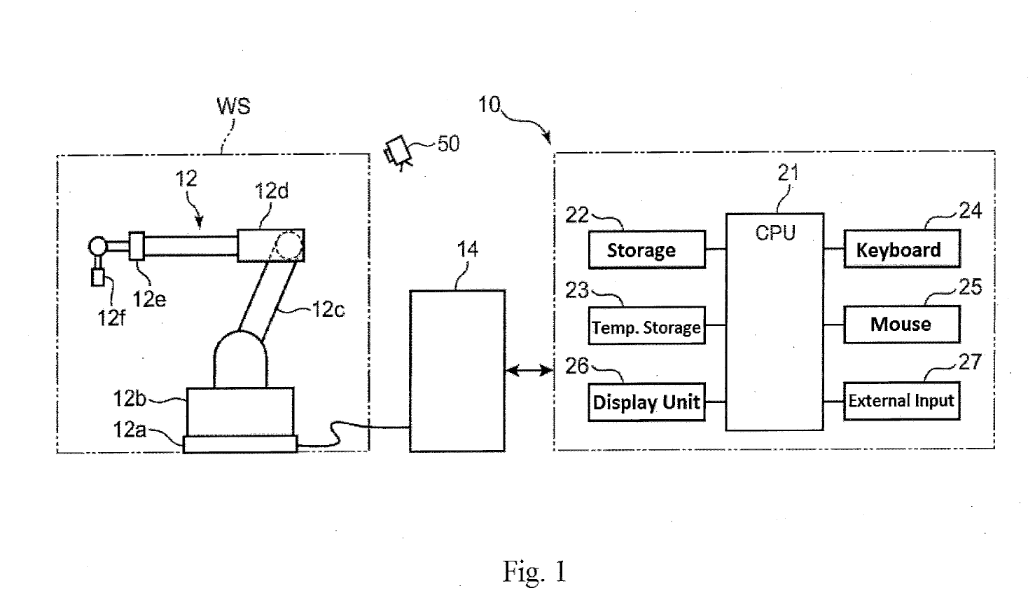

Referring to FIG. 1, a teaching data generating device 10 for a work robot according to an embodiment of the invention (hereunder simply referred to as the teaching data generating device 10) may generate teaching data for teaching, for example, a work robot 12 that may have six axes. The work robot 12 may be used to move an object such as heavy goods from a first position to a second position within a workspace WS. The work robot 12 may include a base 12a, a rotatable base 12b that is configured to rotate relative to the base 12a on a vertical axis, a shank 12c that is coupled to the rotatable base 12b via a joint and is configured to turn on a horizontal axis relative to the rotatable base 12b, an arm supporting portion 12d that is coupled to an upper end of the shank 12c via a joint and is configured to turn on the horizontal axis relative to the shank 12c, a wrist portion 12e that is configured to turn on an axis of the arm supporting portion 12d relative to the arm supporting portion 12d, and a gripper 12f that is hung from an end of the wrist portion 12e via a turning portion.

The work robot 12 may be electrically coupled to a robot controller 14 that is a driving control device for the robot 12 and move in response to a command transmitted by the robot controller 14. The robot controller 14 may store teaching data for specifying motions/operations of the work robot 12. The teaching data may be transmitted from a teaching data generation device 10.

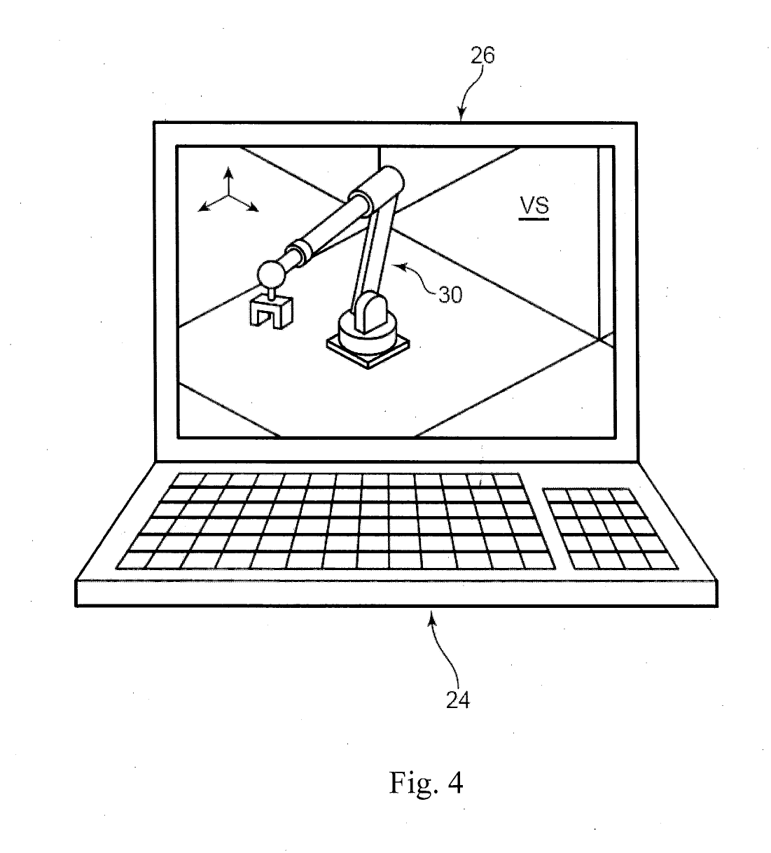

The teaching data generating device 10 may include a processor 21 (CPU), a storage unit 22 (ROM), a temporary storage unit 23 (RAM), a keyboard that serves as an input unit, a mouse 25 that also serves as an input unit, a display unit 26 (display), an external input unit 27 and so on. The storage unit 22 may store programs that allow the teaching data generating device 10 to operate. The storage unit 22 may also store a three-dimensional model 30 of the work robot 12. The three-dimensional model 30 is created by modeling the work robot 12 using software. The three-dimensional model 30 may be used to set up the work robot 12 virtually in a virtual space VS. The three-dimensional model 30 may have the same configuration as the work robot 12 and be able to perform the same motions as the work robot 12 in the virtual space VS. In the same manner as the work robot 12, the three-dimensional model 30 may include, for example, a base 30a, a rotatable base 30b, a shank 30c, an arm supporting portion 30d, a wrist portion 30e, and a gripper 30f. The storage unit 22 may store various three-dimensional models 30 that correspond to various working robots 12 that have different types and sizes respectively (see FIG. 5).

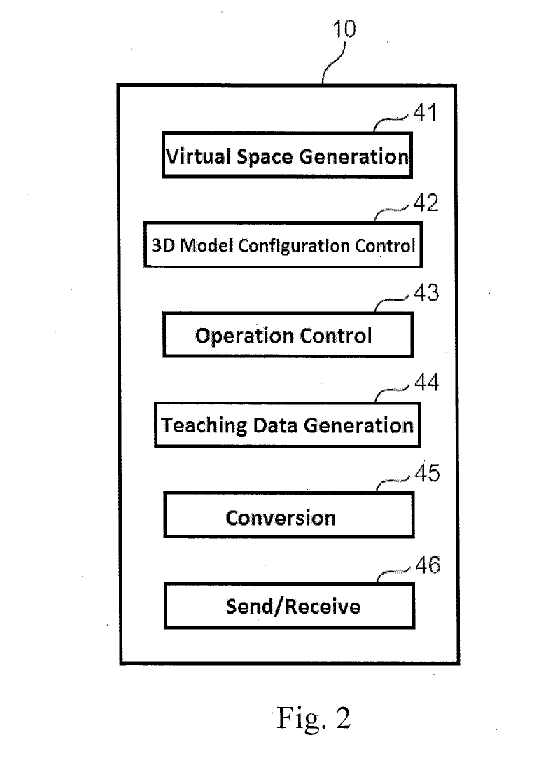

The teaching data generating device 10 may execute a program stored in the storage unit to achieve a predetermined function(s). Referring to FIG. 2, the functions may include a virtual space generating unit 41, a three-dimensional model configuration control unit 42, an operation control unit 43, a teaching data generating unit 44, a conversion unit 45, and a send/receive unit 46. Note that these functions may be realized either by software or hardware.

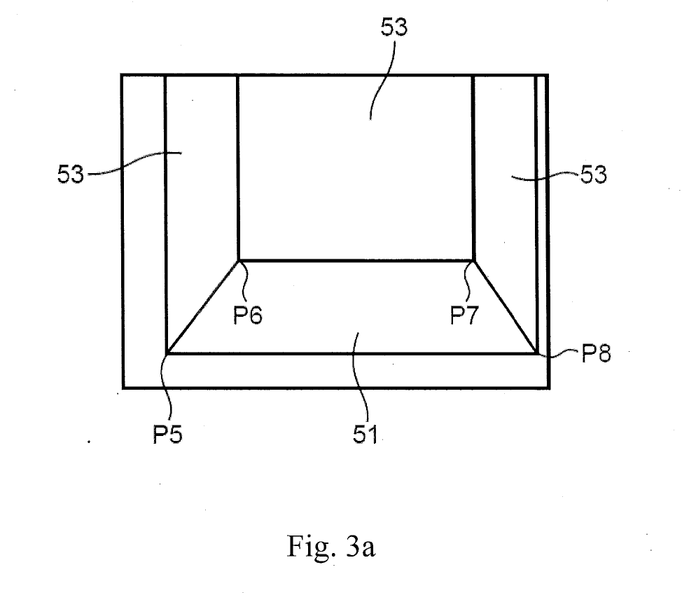

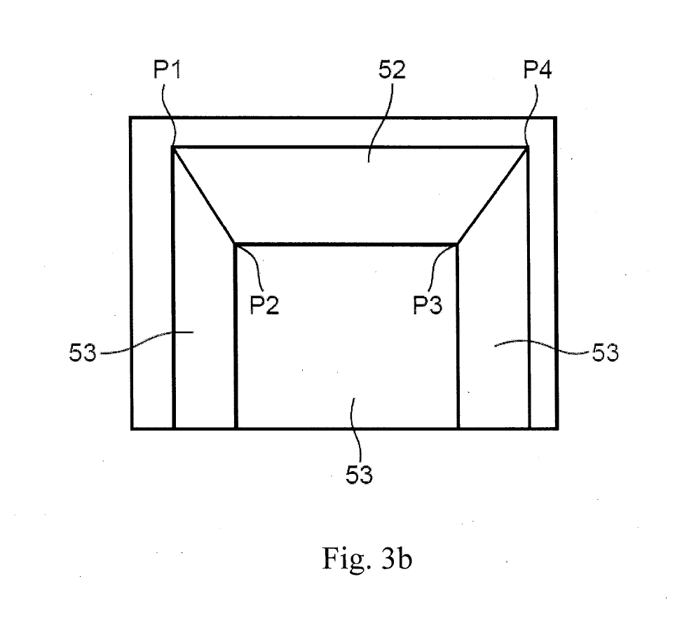

The virtual space generating unit 41 may generate the virtual space VS of the workspace WS (see FIG. 4) based on workspace information that represents the actual workspace WS in which the work robot 12 is disposed. The workspace information may be obtained based on image information that is input through the external input unit 27. More specifically, the image information may be information obtained from an image of the actual workspace WS captured by a camera 50. The image information input via the external input unit 27 may be stored in the storage unit 22. The image information may be obtained from, for example, a plurality of images captured to include a bottom 51, a ceiling 52, and sides 53 of the workspace WS as illustrated in FIGS. 3a and 3b. For simplicity of description, suppose that the workspace WS is a cuboid.

The image information may not be limited to the information obtained from the image(s) captured by the camera 50. Alternatively information obtained from data that is created by a three-dimensional CAD and represents the workspace WS, information obtained from a scan image of the workspace WS that is scanned by a three-dimensional scanner or a laser scanner (not shown) may be used.

The virtual space generating unit 41 may receive an instruction that indicates each vertex of the cuboid of the workspace WS in each image displayed on the display unit 26, and calculate coordinates of each vertex of the workspace WS in a three-dimensional coordinate system. For instance, when a user moves a cursor to and clicks each vertex (for instance, P1, P2, . . . , P8) of the workspace WS on the display unit 26 by using the mouse 25 while the images of FIGS. 3a and 3b are displayed on the display unit 26, the virtual space generating unit 41 calculates the coordinates of each vertex in the three-dimensional coordinate system starting from the clicked position. The information that represents the coordinates of each vertex of the virtual space VS may be the workspace information that represents the substantial workspace WS. The virtual space generating unit 41 may then perform processing using the workspace information to render the workspace WS three-dimensionally on the display unit 26. In this way, the virtual space VS is generated. Referring to FIG. 4, the virtual space VS may be displayed on the display unit 26.

The virtual space generating unit 41 may receive an instruction to adjust the scale of the actual size/dimension of the workspace to the spacial dimension of the virtual workspace in the three-dimensional coordinate system. Therefore the actual size can be calculated any time from the coordinate data in the three-dimensional coordinate system.

The three-dimensional model configuration control unit 42 may perform control to configure a three dimensional model 30 of the work robot 12 at a predetermined position in the virtual space VS displayed on the display unit 26. The three-dimensional model 30 may be selected from the three-dimensional models 30 of the plurality of work robots 12 stored in the storage unit 22. Among the plurality of three-dimensional models 30 stored in the storage unit 22, FIG. 5 illustrates two three-dimensional models 30 of the work robots 12 that have different sizes from each other.

The three-dimensional model configuration control unit 42 may then receive an instruction that specifies the three-dimensional model 30 of the work robot 12 to be selected from among the plurality of three-dimensional models 30 stored in the storage unit 22. The three-dimensional model configuration control unit 42 selects at least one three-dimensional model 30 in accordance with the instruction.

The selection of the three-dimensional model 30 may be performed by, for example, operating the mouse 25 or the keyboard 24 to select one(s) from the list of the three-dimensional models 30 (or work robots 12) shown on the display unit 26 and receiving an instruction that indicates the operation result. In order to select more than one three dimensional model 30 (or more than one work robot 12), the above-described selection process to select the three-dimensional model 30 (the work robot 12) may be repeated to generate the instructions.

Moreover the three-dimensional model configuration control unit 42 may also receive an instruction that specifies the position where the three-dimensional model 30 of the work robot 12 should be disposed in the workspace WS. This instruction may be generated by moving the cursor to a desired position on the display unit 26 that displays the virtual space VS and then clicking the mouse 25, The three-dimensional model configuration control unit 42 may then arrange the selected three-dimensional model 30 of the work robot 12 at the designated position in the virtual space VS in accordance with the instruction. When more than one three-dimensional model 30 are selected, the three-dimensional model configuration control unit 42 may receive an instruction that designates an arrangement of the selected three-directional models 30 and provide the three-dimensional models 30 at the designated positions respectively.

The operation control unit 43 may perform a control to operate the three-dimensional model 30 displayed on the display unit 26 in response to a signal output from the mouse 25 that is operated by a user. The operation control unit 43 may cause the three-dimensional model 30 to make a series of motions that are same as the motions which the work robot 12 is going to perform in response to the signal output from the mouse 25. The motions which the three-dimensional model 30 makes may correspond to motions which the substantial work robot 12 makes. More specifically, a movable part(s) of the three-dimensional model 30 (for instance, the shank 30c) may be selected and dragged by the mouse 25 and then the operation control unit 43 may move the selected part (for instance, the shank 30c) in the manner that simulates the actual motions of the work robot 12.

When more than one three-dimensional model 30 of the work robot 12 are shown on the display unit 26, the operation control unit 43 may receive an instruction that indicates which three-dimensional model 30 to be operated. This instruction may be output by moving the cursor to a desired three-dimensional model 30 and clicking the model 30 by mouse 25. By receiving the instruction to select the three-dimensional models 30 and the instruction to make motions, the three-dimensional models 30 displayed on the display unit 26 may be each operated.

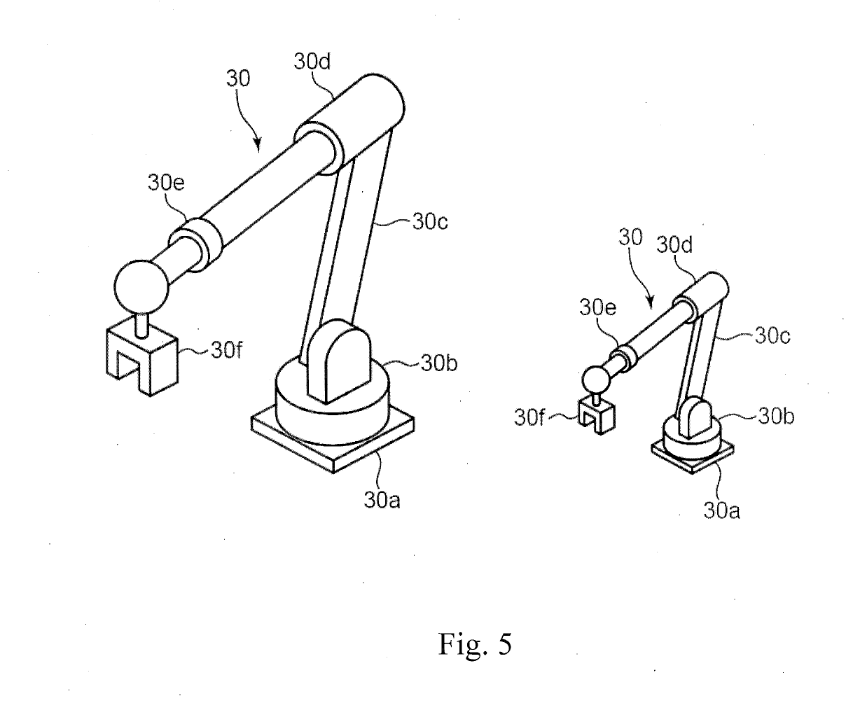

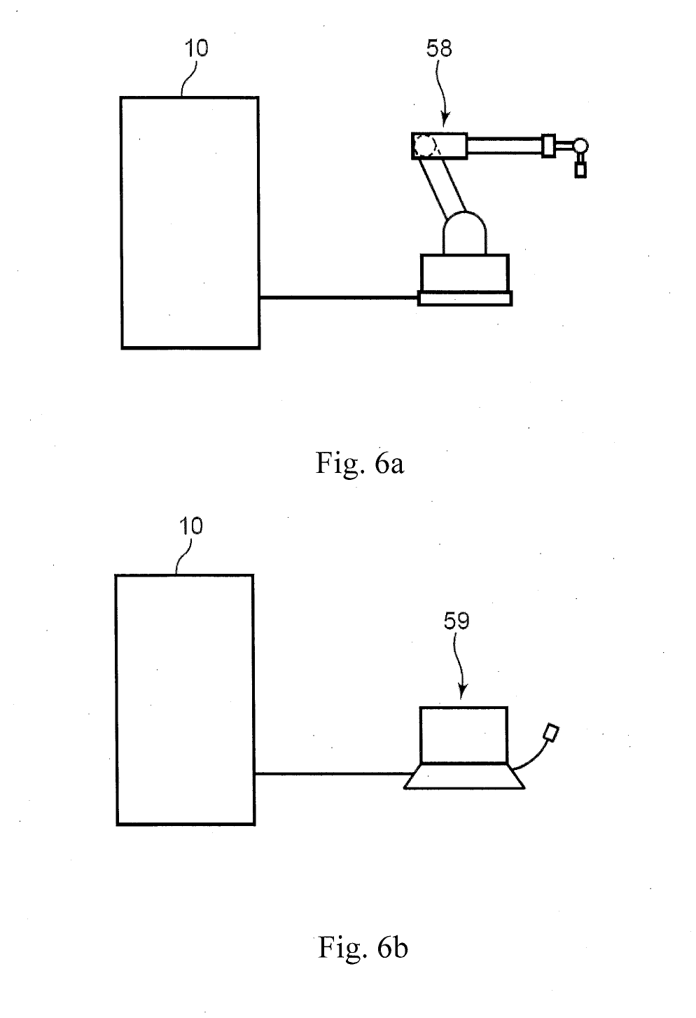

An instruction unit that generates the instructions to be given to the operation control unit 43 may not be limited to the mouse 25. Alternatively, the instruction unit may be a miniature model 58 that is electrically coupled to the external input unit 27 as shown in FIG. 6a. The miniature model 58 is a model that has a size smaller than the actual work robot 12 and the miniature model 58 can be operated either manually and automatically in the same manner as the work robot 12. When any part of the miniature model 58 is operated, the miniature model 58 outputs a corresponding signal In this case, the operation control unit 43 is configured to receive the signal as an instruction to move the three-dimensional model 30.

Alternatively the instruction that gives an instruction to the operation control unit 43 may be obtained by converting speech information that instructs the three-dimensional model 30 displayed on the display unit 26 to operate as illustrated in FIG. 6b. The speech information may be input to a computer 59 that is electrically coupled to the external input unit 27. The computer 59 inputs the information that has been converted from the speech information to the processor 21 through the external input unit 27.

The teaching data generating unit 44 may store data concerning a motion(s) of a part(s) of the three dimensional model 30 such as the shank 12c that is/are operated in accordance with the instruction given from the mouse 25 and the like. The teaching data generating unit 44 may store the data of a motion(s) (for instance, data concerning displacement, turning angle, moving speed, turning speed and the like) in association with the part(s) that made the motion. The teaching data generating unit 44 may generate teaching data based on the stored data. The teaching data may include turning angle information of a joint(s) when a corresponding part(s) is/are displaced in a predetermined amount, displacement information indicating a displacement of each part. These data may be generated for each series of motions which the work robot 12 performs.

The conversion unit 45 may convert the teaching data generated by the teaching data generating unit 44 into a robot language that is used to operate the work robot 12 in response to an instruction. More specifically, the teaching data generating device 10 may store a plurality of three-dimensional models 30 but types of the robot language used to operate the work robots 12 corresponding to the plurality of three-dimensional models 30 may be different from each other. Therefore the conversion unit 45 may convert the teaching data into an instructed robot language based on the instruction input via the keyboard 24 or the mouse 25 or automatically. As for selection of the language into which the teaching data should be converted, the correspondence between languages and robots may be stored in advance in the storage unit 22 or the language may be specified by using the keyboard 24.

The send/receive unit 46 may transmit the teaching data that has been converted into the robot language by the conversion unit 45 (or the teaching data as it is generated by the teaching data generating unit 44 in a case where conversion is not necessary) to the robot controller 14 in response to an instruction from the keyboard 24 or the mouse 25.

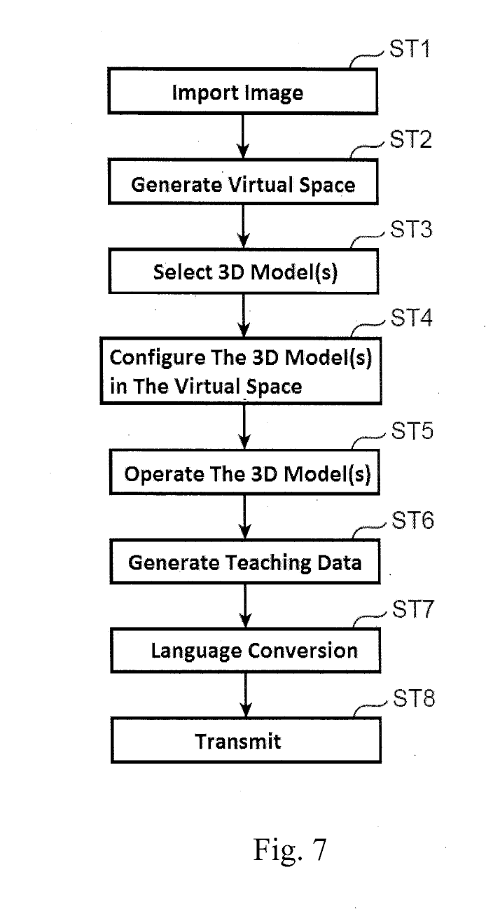

A method of generating teaching data performed by the teaching data generating device 10 will now be described with reference to FIG. 7.

In the teaching data generating method, the virtual space generating unit 41 may firstly import image information (Step ST1). The image information may be information for rendering a captured image of the actual workspace WS. The virtual space generating unit 41 may then generate workspace information from the image information and generate the virtual space VS (Step ST2). More specifically, in Step ST2, the virtual space generating unit 41 may receive an instruction that specifies each vertex of the workspace WS displayed on the display unit 26, and calculate coordinates of each vertex of the workspace WS in the three-dimensional coordinate system. The information that represents the coordinates of each vertex of the virtual space VS may be the workspace information that represents the substantial workspace WS. The virtual space generating unit 41 may then perform processing to render the workspace WS three-dimensionally on the display unit 26 using the workspace information. In this way, the virtual space VS is, generated.

Subsequently the three-dimensional model configuration control unit 42 may receive an instruction to select one or more three-dimensional model(s) 30 from among the three-dimensional models of the plurality of work robots 12 stored in the storage unit 22, and then perform a control to select the one or more three-dimensional models 30 based on the instruction (Step ST3). Here, only one three-dimensional model 30 may be selected or two or more three-dimensional models 30 may be selected. Alternatively Step ST3 may be carried out before Step ST2.

The three-dimensional model configuration control unit 42 may then configure the selected three-dimensional model 30 at the designated position in the virtual space VS (Step ST4). When two or more three-dimensional models 30 are selected, all of the two or more three-dimensional models 30 may be provided at the designated positions respectively.

The operation control unit 43 may operate the three-dimensional model(s) 30 displayed on the display unit 26 (Step ST5). The operation may be based on an instruction(s) provided from the mouse 25 or the like and the three-dimensional model(s) 30 may make a series of motions which the corresponding work robot(s) 12 are going to make. When two or more three-dimensional models 30 are displayed on the display unit 26, the three-dimensional models 30 may be sequentially operated in response to an instruction.

When the three-dimensional model(s) 30 is/are operated, the teaching data generating unit 44 may store data of motions of each operated part of the model(s). Based on the stored data, the teaching data generating unit 44 may generate teaching data for the work robot 12 (Step ST6). The teaching data may be converted into a robot language that is used to operate the work robot 12 if needed (Step ST7). Subsequently the teaching data may be transmitted to the robot controller 14 (Step ST8).

As described above, in the embodiment, the virtual space VS generated based on the workspace information that represents the actual workspace WS is displayed on the display unit 26. In other words, the virtual space VS that simulates the actual workspace WS is displayed on the display unit 26. Therefore, a person who is thinking of introducing a work robot 12 can easily image a state where the work robot 12 is set up in the actual workspace WS. In the virtual space VS, the three-dimensional model 30 of the work robot 12 which is a simulated work robot is provided. The three-dimensional model 30 is a three-dimensional model 30 of at least one work robot 12 selected from among the three-dimensional models 30 of the plurality of work robots 12 stored in the storage unit 22. More specifically, a three-dimensional model 30 of a work robot 12 that a user considers introducing may be selected to configure the model in the virtual space VS. In this way, the display unit 26 can display the state where the work robot 12 that is going to be set up in the actual work site is disposed in the virtual space VS. Therefore the user who considers introducing the work robot 12 can easily image a state, where the work robot 12 is set up in the actual workspace WS. The three-dimensional model 30 of the work robot 12 displayed on the display unit 26 is operated based on the instruction provided from the mouse 25 or the like. The teaching data generating unit 44 generates teaching data for the work robot 12 from data of motions of the three-dimensional model 30, Therefore the teaching data of the work robot 12 can be generated by operating the three-dimensional model 30 while the user images the work robot 12 set up in the actual workspace WS. As a result, it is possible to reduce the load of the teaching process.

Moreover, in the embodiment, the virtual space VS is generated using an image captured by the camera 50, data of three-dimensional CAD, and an image scanned by a scanner. Therefore it is possible to facilitate a process of generating the virtual space VS of the workspace WS of the work robot 12 of which introduction is considered. Consequently the virtual space VS can be readily provided for each workspace WS of the work robot 12 of which introduction is considered.

Furthermore, the teaching data generating device 10 in the embodiment includes the conversion unit 45. Therefore even when different robot languages are used for different types or manufactures of the work robots 12, teaching data for the work robots 12 can be output in the corresponding language.

Moreover, according to the embodiment, the three-dimensional model 30 displayed on the display unit 26 can be operated easily and as the user wishes using the mouse 25 or the like. Therefore it is possible to further reduce the load of the teaching process.

Moreover, according to the embodiment, it is possible to configure three-dimensional models 30 of two or more work robots 12 selected from among three-dimensional models 30 of a plurality of work robots 12 in the virtual space VS and display the models 30 on the display unit 26. Which one of the two or more three-dimensional models 30 to be operated is determined based on an instruction given to the operation control unit 43. The operation control unit 43 may provide an instruction for each of the two or more three-dimensional models 30 in the virtual space VS of the workspace WS in the same manner. Therefore even when more than one work robot 12 are considered to be introduced into a single workspace WS, it is possible to simulate them.

The invention is not limited to the above embodiment but various modifications are possible within a spirit of the invention. For example, the conversion unit 45 may be omitted from the teaching data generating device 10. Moreover, only one three-dimensional model 30 may be displayed on the display unit 26.

The outline of the above-described embodiment will be now described.

(1) In the above-described embodiment, a virtual space that represents an actual workspace is displayed on a display unit. In other words, the virtual space that simulates the actual workspace is displayed on the display unit. Therefore a person who considers introducing a work robot can easily image a state where the work robot is set up in the actual workspace. A three-dimensional model of the work robot which is the simulated work robot is provided in the virtual space. The three-dimension model is at least one three-dimensional model of a work robot selected from among three-dimensional models of a plurality of work robots stored in a storage unit. A user can select a three-dimensional model of the work robot which the user is considering introducing and set it up in the virtual space. Accordingly it is possible to display the state where the work robot that is to be set up in the actual work site is configured in the virtual space. Therefore the person who considers introducing the work robot can easily image the state where the work robot to be introduced is set up in the actual workspace. The three-dimensional model of the work robot displayed on the display unit may be operated based on an instruction supplied by an instruction unit. The teaching data generating unit generates teaching data for the work robot from data of motions of the three-dimensional model. The teaching data of the work robot can be generated by operating the three-dimensional model while a user images the work robot set up in the actual workspace. In this way, it is possible to reduce the load of the teaching process.

(2) The virtual space may be generated using an image of the workspace captured by a camera, data that represents the workspace and is created by a three-dimensional CAD, or a scanned image of the workspace by a three-dimensional scanner or a laser scanner.

In this example, the virtual space may be generated using the captured image by the camera, data generated by the three-dimensional CAD or the scanned image by the scanner. Therefore it is possible to facilitate a process to generate the virtual space of the workspace into which introduction of a robot is considered. In this manner, it is possible to readily provide a virtual space of each workspace where introduction of a robot is considered.

(3) A conversion unit that converts the teaching data into a robot language used to operate the work robot may be provided. In this example, even when different robot languages are used for different types or manufactures of the work robots, teaching data for the work robot can be output in the corresponding language.

(4) The instruction may include a signal that is output when a mouse is operated to manipulate the three-dimensional model displayed on the display unit, a signal that is output in accordance with motions of a miniature model of the work robot, or an instruction generated by converting speech information that is given in order to operate the three-dimensional model displayed on the display unit. In this way, the three-dimensional model displayed on the display unit can be operated easily and as a user wishes. Consequently it is possible to further reduce the load of the teaching process.

(5) Three-dimensional models of two or more work robots selected from among three-dimensional models of a plurality of work robots may be displayed. In this case, the operation control unit may be configured to receive an instruction indicating which one of the three-dimensional models to be displayed on the display unit to be operated.

In this example, the display unit displays the state where the three-dimensional models of the two or more work robots are set up in the virtual space of the workspace. Which one of the two or more dimensional models is to be operated may be determined based on an instruction provided to the operation control unit. The operation control unit may provide an instruction for each of the two or more three-dimensional models in the virtual space of the workspace in the same manner. Therefore the teaching process can be carried out even for the case where more than one work robot are to be introduced into a single workspace.

(6) According to the embodiment, a teaching data generating method for a work robot may include displaying, on a display unit, a virtual space that represents an actual workspace where a work robot is set up and displaying, on the display unit, at least one three-dimensional model selected from among three-dimensional models of a plurality of work robots stored in a storage unit such that the selected model is disposed in the virtual space; operating the three-dimensional model displayed on the display unit in accordance with an instruction to operate the three dimensional model; and generating teaching data for the work robot based on data of motions which the operated three-dimensional model makes.

(7) The teaching data generating method may further include converting the teaching data into a robot language used to operate the work robot.

As described above, according to the embodiment, it is possible to reduce the load of the teaching process in offline teaching.

1. A teaching data generating device for a work robot, comprising:
a storage unit storing three-dimensional models of a plurality of work robots;
a display unit displaying a virtual space that represents an actual workspace where a work robot is set up, the display unit displaying at least one three-dimensional model selected from among the three-dimensional models of the plurality of work robots stored in the storage unit such that the three-dimensional model is configured in the virtual space;
an operation control unit operating the at least one three-dimensional model displayed on the display unit in accordance with an instruction to operate the at least one three-dimensional model; and
a teaching data generating unit generating teaching data for the work robot using data of motions of the at least one three-dimensional model operated by the operation control unit.

2. The teaching data generating device for a work robot according to claim 1, wherein the virtual space is generated using an image of the workspace captured by a camera, data that represents the workspace and is created by a three-dimensional CAD, or a scanned image of the workspace by a three-dimensional scanner or a laser scanner.

3. The teaching data generating device for a work robot according to claim 1, further comprising:
a conversion unit converting the teaching data into a robot language used to operate the work robot.

4. The teaching data generating device for a work robot according to claim 1, wherein the instruction includes a signal that is output when a mouse is operated to operate the at least one three-dimensional model displayed on the display unit, a signal that is output in accordance with motions of a miniature model of the work robot, or an instruction that is generated by converting speech information given to operate the at least one three-dimensional model displayed on the display unit.

5. The teaching data generating device for a work robot according to claim 1, wherein
three-dimensional models of two or more work robots selected from among the three-dimensional models of the plurality of work robots are displayed on the display unit, and
the operation control unit is configured to receive an instruction that indicates which one of the three-dimensional models displayed on the display unit to be operated.

6. A teaching data generating method for a work robot, comprising:
displaying, on a display unit, a virtual space that represents an actual workspace where a work robot is set up and displaying, on the display unit, at least one three-dimensional model selected from among three-dimensional models of a plurality of work robots stored in a storage unit such that the selected model is configured in the virtual space;
operating the at least one three-dimensional model displayed on the display unit in accordance with an instruction to operate the three dimensional model; and
generating teaching data for the work robot based on data of motions that the operated three-dimensional model makes.

7. The teaching data generating method for a work robot according to claim 6, further comprising:
converting the teaching data into a robot language used to operate the work robot.
